(19) United States
(12) Patent Application Publication
(10) Pub. No.: US 2024/0213837 A1
(43) Pub. Date: Jun. 27, 2024

(54) ROTOR, ROTARY ELECTRIC MACHINE, AND DRIVE APPARATUS

(71) Applicant: NIDEC CORPORATION, Kyoto (JP)

(72) Inventor: Kazutoshi MATSUDA, Kyoto (JP)

(21) Appl. No.: 18/456,523

(22) Filed: Aug. 28, 2023

(30) Foreign Application Priority Data
Dec. 26, 2022 (JP) 2022-208294

(51) Int. Cl. H02K 1/32; H02K 1/276

(52) U.S. Cl. CPC H02K 1/32; H02K 1/276; B60K 1/00

(57) ABSTRACT

The present invention is a rotor rotatable about a center axis, and includes a rotor core having a plurality of magnet holes and a flow path through which a refrigerant flows, and a plurality of magnets accommodated in each of the plurality of magnet holes. The plurality of magnet holes and the flow path each extend in the axial direction. When viewed in the axial direction, the flow path is surrounded by the plurality of magnets. The plurality of magnets include a first magnet and a second magnet. The plurality of magnet holes include a first magnet hole accommodating the first magnet and a second magnet hole accommodating the second magnet. The first magnet is disposed radially outside the second magnet. When viewed in the axial direction, the shortest distance between the flow path and the first magnet is shorter than the shortest distance between the flow path and the second magnet.

### CROSS-REFERENCE TO RELATED APPLICATIONS

The present invention claims priority under 35 U.S.C. § 119 to Japanese Patent Application No. 2022-208294 filed on Dec. 26, 2022, the entire content of which is incorporated herein by reference.

### FIELD OF THE INVENTION

The present invention relates to a rotor, a rotary electric machine, and a drive apparatus.

### BACKGROUND

A rotary electric machine in which a permanent magnet is accommodated in a through hole of a rotor is known. For example, there is a rotor including a V-shaped magnet in which a pair of permanent magnets is arranged at a V-shaped opening angle toward an outer peripheral surface of the rotor, and an outer magnet disposed at a portion where the V-shaped magnet is opened.

In the rotor described above, since the outer magnet is disposed radially outside the V-shaped magnet, the magnetic flux passing through the outer magnet is larger than the magnetic flux passing through the V-shaped magnet. Therefore, when the rotor rotates, the amount of change in the magnetic flux passing through the outer magnet is larger than the amount of change in the magnetic flux passing through the V-shaped magnet. As a result, since the eddy current generated in the V-shaped magnet increases, the amount of Joule heat generated in the outer magnet is larger than the amount of Joule heat generated in the V-shaped magnet. Therefore, when the rotor rotates, the temperature of the outer magnet becomes higher than the temperature of the V-shaped magnet, so that the outer magnet is easily demagnetized, and the output efficiency of the rotary electric machine may be reduced.

### SUMMARY

One aspect of an exemplary rotor of the present invention is a rotor rotatable about a center axis, and includes a rotor core having a plurality of magnet holes and a flow path through which a refrigerant flows, and a plurality of magnets accommodated in each of the plurality of magnet holes. The plurality of magnet holes and the flow path each extend in the axial direction. When viewed in the axial direction, the flow path is surrounded by the plurality of magnets. The plurality of magnets include a first magnet and a second magnet. The plurality of magnet holes include a first magnet hole that accommodates the first magnet and a second magnet hole that accommodates the second magnet. The first magnet is disposed radially outside the second magnet. When viewed in the axial direction, a shortest distance between the flow path and the first magnet is shorter than a shortest distance between the flow path and the second magnet.

One aspect of an exemplary rotary electric machine of the present invention includes the above-described rotor and a stator disposed radially outside the rotor.

One aspect of an exemplary drive apparatus according to the present invention includes the above rotary electric machine, and a gear mechanism connected to the rotor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating a drive apparatus according to a first embodiment;

FIG. 2 is a cross-sectional view illustrating a rotor in the first embodiment;

FIG. 3 is a cross-sectional view illustrating a part of the rotor in the first embodiment;

FIG. 4 is a cross-sectional view illustrating a part of the rotor of the first embodiment, and is a partially enlarged view of FIG. 3;

FIG. 5 is a cross-sectional view illustrating a part of a rotor of a modification of the first embodiment; and

FIG. 6 is a cross-sectional view illustrating a part of a rotor in a second embodiment.

### DETAILED DESCRIPTION

The following description will be made with a vertical direction being defined on the basis of the positional relationship in a case where the drive apparatus of the embodiment is mounted in a vehicle positioned on a horizontal road surface. That is, it is sufficient that the positional relationship regarding the vertical direction described in the following embodiment is satisfied in the case where the drive apparatus is mounted in a vehicle positioned on a horizontal road surface.

Each drawing illustrates an XYZ coordinate system appropriately as a three-dimensional orthogonal coordinate system. In the XYZ coordinate system, a Z-axis direction corresponds to the vertical direction. A +Z side is an upward vertical direction, and a −Z side is a downward vertical direction. In the following description, the upper side in the vertical direction will be referred to simply as the “upper side” or “one axial direction side”, and the lower side in the vertical direction will be referred to simply as the “lower side”. An X axis direction is a direction orthogonal to the Z axis direction and is a front-rear direction of the vehicle mounted with the drive apparatus. In the following embodiment, a +X side is a front side of the vehicle, and a −X side is a rear side of the vehicle. A Y axis direction is a direction orthogonal to both the X axis direction and the Z axis direction, and is a left-right direction of the vehicle, i.e., a vehicle width direction. In the following embodiment, a +Y side is a left side of the vehicle, and a −Y side is a right side of the vehicle. In the following description, the left side in the vehicle is simply referred to as “left side”, and the right side in the vehicle is simply referred to as “right side”.

Note that the positional relationship in the front-rear direction is not limited to the positional relationship in the following embodiment, and the +X side may be the rear side of the vehicle and the −X side may be the front side of the vehicle. In this case, the +Y side corresponds to the right side of the vehicle, while the −Y side corresponds to the left side of the vehicle. In the present specification, a “parallel direction” includes a substantially parallel direction, and an “orthogonal direction” includes a substantially orthogonal direction.

The center axis J illustrated in each drawing is a virtual axis extending in the Y-axis direction, that is, the left-right direction of the vehicle. In the following description, unless otherwise particularly stated, a direction parallel to the center axis J is simply referred to as the “axial direction”, a radial direction about the center axis J is simply referred to as the “radial direction”, and a circumferential direction about the center axis J, i.e., a direction around the center axis J is simply referred to as the “circumferential direction”.

The circumferential direction is indicated by an arrow θ in each drawing. A side (+θ side) to which the arrow θ is directed in the circumferential direction is referred to as “one circumferential direction side”. A side (−θ side) opposite to the side to which the arrow θ is directed in the circumferential direction is referred to as “the other circumferential direction side”. The one circumferential direction side is a side that advances clockwise around the center axis J when viewed from the right side (−Y side). The other side in the circumferential direction is a side that advances counterclockwise around the center axis J when viewed from the right side.

In the following description, “radially outside” includes a case where, when one direction is decomposed into a component facing the radial direction and a component facing the circumferential direction, the component facing the radial direction faces radially outside. Similarly, “radially inside” includes a case where a component facing in the radial direction faces radially inside when one direction is decomposed into a component facing in the radial direction and a component facing in the circumferential direction. In addition, “one circumferential direction side” includes a case where a component facing the circumferential direction faces one circumferential direction side when one direction is decomposed into a component facing the radial direction and a component facing the circumferential direction. Similarly, “the other circumferential direction side” includes a case where a component facing in the circumferential direction faces the other circumferential direction side when one direction is decomposed into a component facing in the radial direction and a component facing in the circumferential direction.

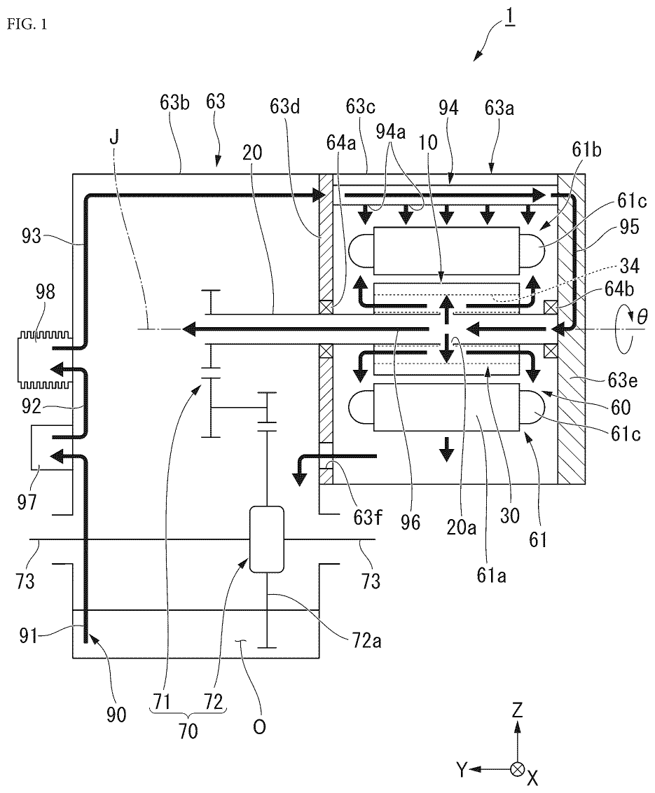

A drive apparatus 1 of the present embodiment illustrated in FIG. 1 is a drive apparatus that is mounted in a vehicle and rotates an axle 73. The vehicle on which the drive apparatus 1 is mounted is a vehicle including a motor as a power source, such as a hybrid vehicle (HEV), a plug-in hybrid vehicle (PHV), or an electric vehicle (EV). The drive apparatus 1 includes a rotary electric machine 60, a gear mechanism 70 connected to the rotary electric machine 60, a housing 63 accommodating the rotary electric machine 60 and the gear mechanism 70 therein, and a refrigerant flow path 90. In the present embodiment, the rotary electric machine 60 is a motor.

The housing 63 accommodates the rotary electric machine 60 and the gear mechanism 70 therein. The housing 63 includes a motor housing 63a that accommodates the rotary electric machine 60 therein and a gear housing 63b that accommodates the gear mechanism 70 therein. The motor housing 63a is connected to the right side (−Y side) of the gear housing 63b. The motor housing 63a has a peripheral wall portion 63c, a partition wall portion 63d, and a lid portion 63e. The peripheral wall portion 63c and the partition wall portion 63d are each a part of an identical single member, for example. The lid portion 63e is, for example, a separate body from the peripheral wall portion 63c and the partition wall portion 63d.

The peripheral wall portion 63c has a tubular shape that surrounds the center axis J and is open toward the right side (−Y side). The peripheral wall portion 63c surrounds the rotary electric machine 60 from radially outside. The partition wall portion 63d is connected to an end portion on the left side (+Y side) of the peripheral wall portion 63c. The partition wall portion 63d axially separates an inside of the motor housing 63a and an inside of the gear housing 63b. The partition wall portion 63d has a partition opening 63f that connects the inside of the motor housing 63a and the inside of the gear housing 63b. A bearing 64a is held by the partition wall portion 63d. The lid portion 63e is fixed to the right end portion of the peripheral wall portion 63c. The lid portion 63e closes the opening on the right side of the peripheral wall portion 63c. A bearing 64b is held by the lid portion 63e.

The gear housing 63b accommodates a refrigerant O therein. The refrigerant O is stored in a lower region in the gear housing 63b. The refrigerant O circulates through the refrigerant flow path 90. In the present embodiment, the refrigerant O is lubricating oil that cools the rotary electric machine 60 and lubricates the gear mechanism 70. As the refrigerant O, for example, oil equivalent to an automatic transmission fluid (ATF) having a relatively low viscosity is preferably used for the refrigerant function and the lubricating function.

The gear mechanism 70 is connected to a rotor 10 (to be described later) of the rotary electric machine 60, and transmits rotation about the center axis J of the rotor 10 to the axle 73 of the vehicle. The gear mechanism 70 according to the present embodiment includes the reduction gear 71 connected to the rotary electric machine 60, and the differential device 72 connected to the reduction gear 71. The differential device 72 includes a ring gear 72a. To the ring gear 72a, torque output from the rotary electric machine 60 is transmitted via the reduction gear 71. The ring gear 72a has a lower end portion being immersed in the refrigerant O stored in the gear housing 63b. When the ring gear 72a rotates, the refrigerant O is scraped up, and the scraped-up refrigerant O lubricates the reduction gear 71 and the differential device 72.

The rotary electric machine 60 includes the rotor 10 rotatable about the center axis J, and a stator 61 facing the rotor 10 with a gap radially interposed therebetween. In the present embodiment, the stator 61 is disposed radially outside the rotor 10. The stator 61 is fixed to an inner circumferential surface of the peripheral wall portion 63c of the housing 63. The stator 61 includes a stator core 61a and a coil assembly 61b attached to the stator core 61a.

The stator core 61a has a substantially annular shape centered on the center axis J. The stator core 61a surrounds a rotor core 30, which will be described later, of the rotor 10 from radially outside. The coil assembly 61b includes a plurality of coils 61c attached to the stator core 61a. Although not illustrated, the coil assembly 61b may include a binding member or the like to bind the respective coils 61c together, and may include a passage line for joining the coils 61c to one another.

Although not illustrated, the coil assembly 61b is electrically connected to an external power source (not illustrated). When a current is supplied from the external power source to the coil assembly 61b, each of the plurality of coils 61c constitutes an electromagnet. At this time, Joule heat is generated in each of the plurality of coils 61c, and the Joule heat is transmitted to the stator core 61a. As a result, the temperature of the stator 61 including the stator core 61a increases.

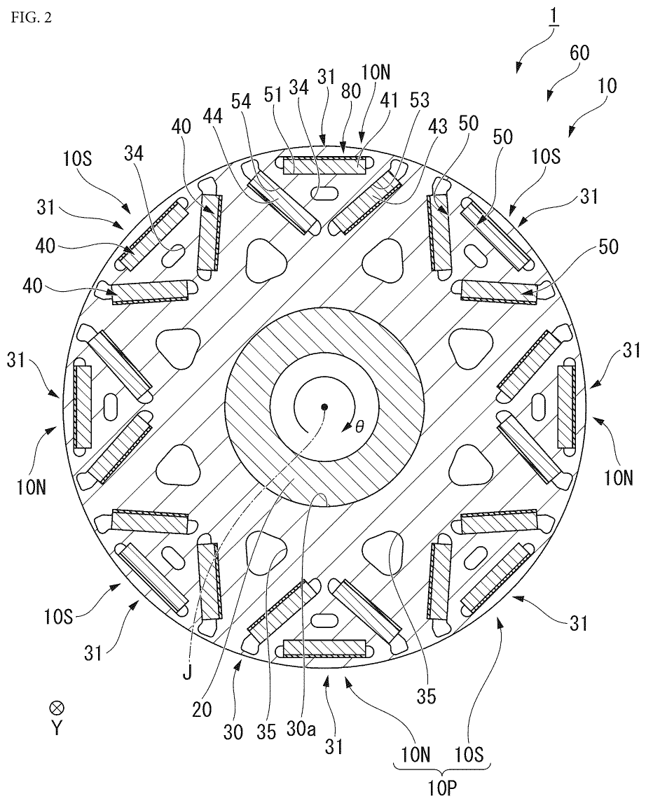

As illustrated in FIG. 2, the rotor 10 includes a shaft 20, a rotor core 30, a plurality of magnets 40, and a low thermal conductive layer 80. As illustrated in FIG. 1, the shaft 20 has a cylindrical shape extending axially about the center axis J. The shaft 20 opens to the left side (+Y side) and the right side (−Y side). The left end portion of the shaft 20 protrudes into the gear housing 63b. The shaft 20 is provided with a hole portion 20a that connects the inside of the shaft 20 and the outside of the shaft 20. A plurality of hole portions 20a are provided at intervals in the circumferential direction.

The rotor core 30 is fixed to an outer peripheral surface of the shaft 20. The rotor core 30 has a substantially annular shape centered on the center axis J. The rotor core 30 is made of a magnetic body. Although not illustrated, the rotor core 30 includes a plurality of plate members laminated in the axial direction. The plate member is, for example, an electromagnetic steel plate. As illustrated in FIG. 2, the rotor core 30 includes a through hole 30a, a plurality of magnet holding portions 31, a plurality of intra-rotor flow paths 34, and a plurality of rotor hole portions 35.

The through hole 30a is a hold axially penetrating the rotor core 30. When viewed in the axial direction, the through hole 30a has a substantially circular shape centered on the center axis J. The shaft 20 passes through the through hole 30a in the axial direction. The inner circumferential surface of the through hole 30a is fixed to the outer peripheral surface of the shaft 20.

The plurality of magnet holding portions 31 are provided in a portion on a radially outside of the rotor core 30. The plurality of magnet holding portions 31 are disposed at equal intervals over the entire circumference along the circumferential direction. In the present embodiment, eight magnet holding portions 31 are provided. In the present embodiment, each magnet holding portion 31 is provided with one intra-rotor flow path 34 and three magnet holes 50.

The plurality of magnet holes 50 extend in the axial direction. In the present embodiment, each magnet hole 50 is a hole penetrating the rotor core 30 in the axial direction. Each magnet hole 50 may be a hole having a bottom at an axial end portion. In the present embodiment, the plurality of magnet holes 50 include a first magnet hole 51 and second magnet holes 53 and 54 provided on the radially inside of the first magnet hole 51. Each of the plurality of magnet holding portions 31 is provided with one first magnet hole 51 and a pair of second magnet holes 53 and 54.

One of the plurality of magnets 40 is accommodated in each of the plurality of magnet holes 50. In the present embodiment, each of the plurality of magnets 40 has a substantially rectangular parallelepiped shape extending in the axial direction. Each magnet 40 extends, for example, from the left end portion (+Y side) to the right end portion (−Y side) of the rotor core 30. In the present embodiment, the magnet 40 is a permanent magnet. In the present embodiment, the magnet 40 is a neodymium magnet that does not contain heavy rare earths such as dysprosium and terbium. Therefore, although the magnet 40 of the present embodiment has a lower demagnetization temperature than a neodymium magnet containing heavy rare earths, the material cost can be reduced. Therefore, the manufacturing cost of the magnet 40 can be reduced.

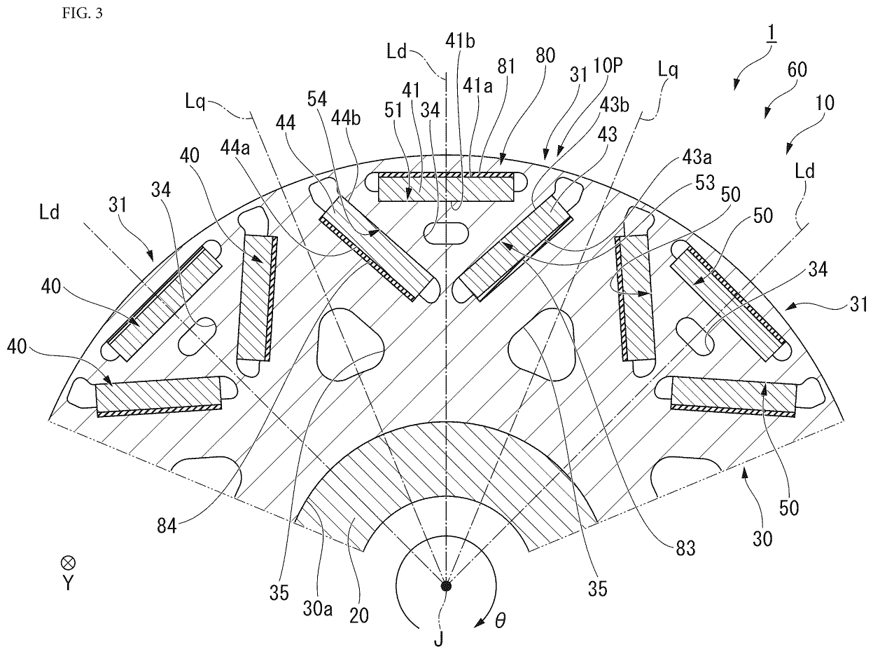

As illustrated in FIG. 3, the plurality of magnets 40 include a first magnet 41 accommodated in the first magnet hole 51 and a pair of second magnets 43 and 44 accommodated in the pair of second magnet holes 53 and 54, respectively. Each magnet 40 is fixed in each magnet hole 50 by low thermal conductive layers 81, 83, and 84 described later.

As illustrated in FIG. 2, the rotor 10 includes a plurality of magnetic poles 10P. A plurality of magnetic poles 10P are disposed at equal intervals over the entire circumference along the circumferential direction. In the present embodiment, eight magnetic poles 10P are provided. Each of the plurality of magnetic poles 10P includes one magnet holding portion 31 of the rotor core 30 and a plurality of magnets 40 accommodated in the magnet hole 50 provided in the one magnet holding portion 31. Each of the plurality of magnetic poles 10P includes one first magnet hole 51, a pair of second magnet holes 53 and 54, one first magnet 41, and a pair of second magnets 43 and 44. The plurality of magnetic poles 10P include four magnetic poles 10N in which the magnetic pole on the outer peripheral surface of the rotor core 30 is an N pole and four magnetic poles 10S in which the magnetic pole on the outer peripheral surface of the rotor core 30 is an S pole. Four of the magnetic poles 10N and four of the magnetic poles 10S are alternately arranged along the circumferential direction.

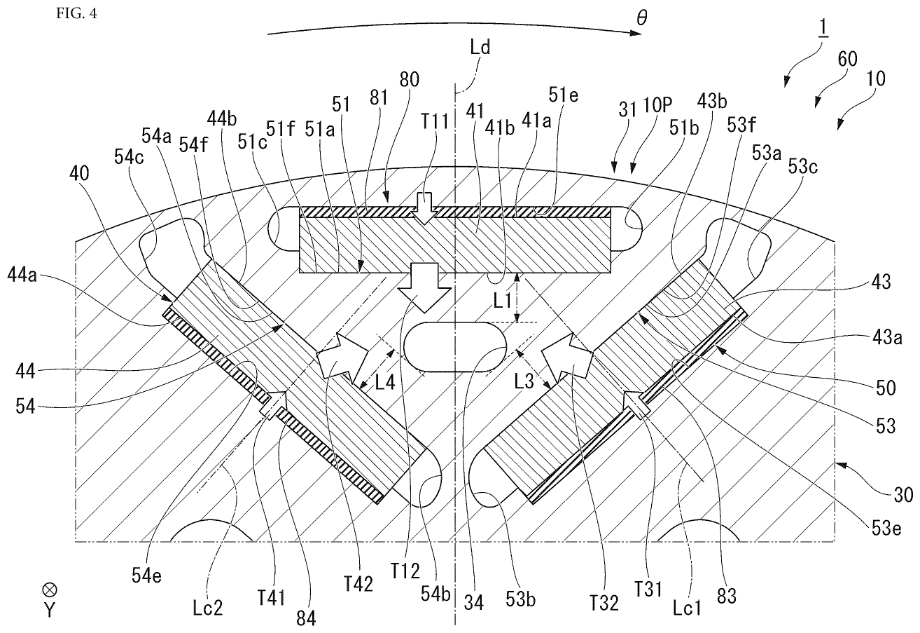

As illustrated in FIG. 4, in the magnetic pole 10P, the second magnet hole 53 and the second magnet hole 54 are disposed with a magnetic pole virtual line Ld interposed therebetween in the circumferential direction. The magnetic pole virtual line Ld is a virtual line that passes through the circumferential center of the magnetic pole 10P and extends in the radial direction. The magnetic pole virtual line Ld is provided in each of the magnetic poles 10P. The magnetic pole virtual line Ld passes through on a d axis of the rotor 10 when viewed in the axial direction. A direction where the magnetic pole virtual line Ld extends is a d-axis direction of the rotor 10. The magnetic pole virtual line Ld passes through the center in the circumferential direction between the pair of second magnet holes 53 and 54. In the present embodiment, the circumferential center of the magnetic pole 10P is the circumferential center of the magnet holding portion 31.

The first magnet hole 51 is disposed radially outside the pair of second magnet holes 53 and 54. The first magnet hole 51 is disposed between the pair of second magnet holes 53 and 54 in the circumferential direction. More specifically, the first magnet hole 51 is disposed between the radially outer end portions of the pair of second magnet holes 53 and 54. When viewed in the axial direction, the first magnet hole 51 extends in a direction orthogonal to the magnetic pole virtual line Ld. The magnetic pole virtual line Ld passes through the circumferential center of the first magnet hole 51. When viewed in the axial direction, a portion on one circumferential direction side (+θ side) with respect to the magnetic pole virtual line Ld of the first magnet hole 51 and a portion on the other circumferential direction side (−θ side) have a line-symmetrical shape with the magnetic pole virtual line Ld as a symmetry axis.

The first magnet hole 51 includes a magnet accommodation hole portion 51a and two outer hole portions 51b and 51c. When viewed in the axial direction, the magnet accommodation hole portion 51a has a rectangular shape with the direction in which the first magnet hole 51 extends as a long side. The magnet accommodation hole portion 51a is disposed on the radially outside of the intra-rotor flow path 34. The magnet accommodation hole portion 51a has a first inner surface 51e and a second inner surface 51f. The first inner surface 51e is a surface facing the radially inside among the inner surfaces of the magnet accommodation hole portion 51a. The second inner surface 51f is a surface facing radially outside among the inner surfaces of the magnet accommodation hole portion 51a.

The first magnet 41 is accommodated in the first magnet hole 51. More specifically, the first magnet 41 is accommodated in the magnet accommodation hole portion 51a. The first magnet 41 is disposed radially outside the pair of second magnets 43 and 44. The first magnet 41 is disposed radially outside of the intra-rotor flow path 34. When viewed in the axial direction, the first magnet 41 extends in a direction orthogonal to the magnetic pole virtual line Ld. When viewed in the axial direction, the first magnet 41 is disposed at a position overlapping the magnetic pole virtual line Ld. The first magnet 41 has a first outer surface 41a and a second outer surface 41b. The first outer surface 41a is a surface of the outer surface of the first magnet 41 that faces the radially outside, that is, the side opposite to the intra-rotor flow path 34 side. The first outer surface 41a faces the first inner surface 51e in the radial direction. The second outer surface 41b is a surface facing the radially inside, that is, the intra-rotor flow path 34 side, of the outer surface of the first magnet 41. The second outer surface 41b faces the second inner surface 51f in the radial direction.

The outer hole portion 51b is connected to an end portion on one circumferential direction side (+θ side) of the magnet accommodation hole portion 51a. The outer hole portion 51c is connected to an end portion on the other circumferential direction side (−θ side) of the magnet accommodation hole portion 51a. The outer hole portions 51b and 51c are, for example, hollow portions, and each constitute a flux barrier portion. The outer hole portions 51b and 51c may be filled with a nonmagnetic material such as resin, and the flux barrier portion may be constituted by the nonmagnetic material. In the present specification, the “flux barrier portion” is a portion of the rotor core 30 that can suppress passage of magnetic flux.

The pair of second magnet holes 53 and 54 is disposed radially inside the first magnet hole 51. When viewed in the axial direction, the pair of second magnet holes 53 and 54 extends in directions away from each other in the circumferential direction from radially inside toward radially outside. When viewed in the axial direction, the pair of second magnet holes 53 and 54 are disposed along a V shape expanding in the circumferential direction toward the radially outside. The second magnet hole 53 is disposed on one circumferential direction side (+θ side) of the intra-rotor flow path 34. The second magnet hole 54 is disposed on the other circumferential direction side (−θ side) of the intra-rotor flow path 34. When viewed in the axial direction, the second magnet hole 53 and the second magnet hole 54 have a line-symmetric shape with the magnetic pole virtual line Ld as a symmetry axis.

The second magnet hole 53 includes a magnet accommodation hole portion 53a, an inner hole portion 53b, and an outer hole portion 53c. When viewed in the axial direction, the magnet accommodation hole portion 53a has a rectangular shape with the direction in which the second magnet hole 53 extends as a long side. The magnet accommodation hole portion 53a is disposed on one circumferential direction side (+θ side) of the intra-rotor flow path 34. The magnet accommodation hole portion 53a has a first inner surface 53e and a second inner surface 53f. The first inner surface 53e is a surface facing the intra-rotor flow path 34 side among the inner surfaces of the magnet accommodation hole portion 53a. The second inner surface 53f is a surface facing the side opposite to the intra-rotor flow path 34 side among the inner surfaces of the magnet accommodation hole portion 53a. When viewed in the axial direction, the inner hole portion 53b is connected to the radially inner end portion of the magnet accommodation hole portion 53a. When viewed in the axial direction, the outer hole portion 53c is connected to the radially outer end portion of the magnet accommodation hole portion 53a. The inner hole portion 53b and the outer hole portion 53c constitute a flux barrier portion.

The second magnet hole 54 includes a magnet accommodation hole portion 54a, an inner hole portion 54b, and an outer hole portion 54c. When viewed in the axial direction, the magnet accommodation hole portion 54a has a rectangular shape with the direction in which the second magnet hole 54 extends as a long side. The magnet accommodation hole portion 54a is disposed on the other circumferential direction side (−θ side) of the intra-rotor flow path 34. The magnet accommodation hole portion 54a has a first inner surface 54e and a second inner surface 54f. The first inner surface 54e is a surface facing the intra-rotor flow path 34 side among the inner surfaces of the magnet accommodation hole portion 54a. The second inner surface 54f is a surface facing the side opposite to the intra-rotor flow path 34 side among the inner surfaces of the magnet accommodation hole portion 54a. When viewed in the axial direction, the inner hole portion 54b is connected to the radially inner end portion of the magnet accommodation hole portion 54a. When viewed in the axial direction, the outer hole portion 54c is connected to the radially outer end portion of the magnet accommodation hole portion 54a. The inner hole portion 54b and the outer hole portion 54c constitute a flux barrier portion.

When viewed in the axial direction, the pair of second magnets 43 and 44 extend in directions away from each other in the circumferential direction toward the radially outside from the radially inside. When viewed in the axial direction, the pair of second magnets 43 and 44 are disposed along a V shape expanding in the circumferential direction toward the radial outside. The second magnet 43 is disposed in the magnet accommodation hole portion 53a. The second magnet 43 is disposed on one circumferential direction side (+θ side) of the intra-rotor flow path 34. The second magnet 44 is disposed in the magnet accommodation hole portion 54a. The second magnet 44 is disposed on the other circumferential direction side (−θ side) of the intra-rotor flow path 34. As described above, the first magnet 41 is disposed radially outside the intra-rotor flow path 34. As a result, the intra-rotor flow path 34 is surrounded by the plurality of magnets 40 when viewed in the axial direction.

The second magnet 43 has a first outer surface 43a and a second outer surface 43b. The first outer surface 43a is a surface of the outer surface of the second magnet 43 facing the side opposite to the intra-rotor flow path 34 side. The first outer surface 43a faces the first inner surface 53e. The second outer surface 43b is a surface of the outer surface of the second magnet 43 facing the intra-rotor flow path 34 side. The second outer surface 43b faces the second inner surface 53f.

The second magnet 44 has a first outer surface 44a and a second outer surface 44b. The first outer surface 44a is a surface of the outer surface of the second magnet 44 facing the side opposite to the intra-rotor flow path 34 side. The first outer surface 44a faces the first inner surface 54e. The second outer surface 44b is a surface of the outer surface of the second magnet 44 facing the intra-rotor flow path 34 side. The second outer surface 44b faces the second inner surface 54f.

As illustrated in FIG. 1, in the present embodiment, the plurality of intra-rotor flow paths 34 are holes penetrating the rotor core 30 in the axial direction. The plurality of intra-rotor flow paths 34 are flow paths through which the refrigerant O flows. The plurality of intra-rotor flow paths 34 extend in the axial direction. The substantially axial center portions of the plurality of intra-rotor flow paths 34 are radially connected to the plurality of hole portions 20a of the shaft 20. As illustrated in FIG. 2, in the present embodiment, eight intra-rotor flow paths 34 are provided. Each of the intra-rotor flow paths 34 is provided at equal intervals over the entire circumference along the circumferential direction. One each of the intra-rotor flow paths 34 is provided in each magnet holding portion 31.

In each magnet holding portion 31, the intra-rotor flow path 34 is disposed radially inside the first magnet 41. In the circumferential direction, the intra-rotor flow path 34 is disposed between the pair of second magnets 43 and 44. As described above, the intra-rotor flow path 34 is surrounded by the one first magnet 41 and the pair of second magnets 43 and 44. Each of the intra-rotor flow paths 34 constitutes a part of the refrigerant flow path 90 through which the refrigerant O flows. The heat of the rotor core 30 and the heat of the plurality of magnets 40 are transmitted to the refrigerant O flowing through the intra-rotor flow path 34 and released via the refrigerant O.

As illustrated in FIG. 4, when viewed in the axial direction, the intra-rotor flow path 34 is disposed radially inside a first virtual line Lc1 that is orthogonal to the direction in which one second magnet 43 extends and passes through the center of the second magnet 43 in the direction in which the second magnet 43 extends. In the present invention, the arrangement on the radial inside of the first virtual line Lc1 means that the rotor core 30 is disposed in a region located on the radial inside of the two regions when the rotor core is divided into the two regions with the first virtual line Lc1 as a boundary when viewed in the axial direction. In addition, the intra-rotor flow path 34 is orthogonal to the direction in which the other second magnet 44 extends, and is disposed radially inside the second virtual line Lc2 passing through the center of the second magnet 44 in the direction in which the second magnet 44 extends. In the present invention, the arrangement on the radial inside of the second virtual line Lc2 means that the rotor core 30 is disposed in a region located on the radial inside of the two regions when the rotor core is divided into the two regions with the second virtual line Lc2 as a boundary when viewed in the axial direction. Therefore, according to the present embodiment, it is possible to suppress the shortest distance between the intra-rotor flow path 34 and each of the first magnet hole 51 and the second magnet holes 53 and 54 from becoming too short. Therefore, it is possible to prevent the thickness of the rotor core 30 between the intra-rotor flow path 34 and the first magnet hole 51 and the second magnet holes 53 and 54 from becoming too thin, and it is thus possible to prevent the rigidity of the portion of the rotor core 30 surrounded by the plurality of magnets 40 from deteriorating.

As illustrated in FIG. 3, the intra-rotor flow path 34 is provided at a position overlapping the magnetic pole virtual line Ld when viewed in the axial direction. In the present embodiment, the intra-rotor flow path 34 has an elongated hole shape extending in a direction orthogonal to the magnetic pole virtual line Ld when viewed in the axial direction. In the present embodiment, a portion of the intra-rotor flow path 34 on one circumferential direction side (+θ side) with respect to the magnetic pole virtual line Ld and a portion of the intra-rotor flow path 34 on the other side (−θ side) in the circumferential direction with respect to the magnetic pole virtual line Ld have a line-symmetrical shape with the magnetic pole virtual line Ld as a symmetry axis. When viewed in the axial direction, both ends of the intra-rotor flow path 34 in the circumferential direction have an arc shape protruding outward in the circumferential direction. In the present embodiment, the circumferential outside is a direction facing the opposite side of the direction facing the magnetic pole virtual line Ld side. Therefore, according to the present embodiment, it is possible to suppress concentration of stress on a part of the inner surface of the intra-rotor flow path 34 as compared with a case where the shape of the intra-rotor flow path 34 is a shape having a corner portion such as a rectangular shape when viewed in the axial direction. Therefore, when the rotor 10 rotates about the center axis J, the intra-rotor flow path 34 can be suppressed from being deformed by the centrifugal force or the like applied to the rotor core 30. Therefore, the flow rate of the refrigerant O flowing through the intra-rotor flow path 34 can be stabilized. Therefore, since the heat of the rotor core 30 and the plurality of magnets 40 can be stably released via the refrigerant O, the temperature rise of the plurality of magnets 40 can be suppressed. When viewed in the axial direction, the intra-rotor flow path 34 may have another shape such as a circular shape. In addition, since it is possible to suppress concentration of stress on a part of the inner surface of the intra-rotor flow path 34, it is possible to suppress generation of a crack or the like in the intra-rotor flow path 34.

As described above, the intra-rotor flow path 34 is surrounded by the one first magnet 41 and the pair of second magnets 43 and 44. As illustrated in FIG. 4, when viewed in the axial direction, the shortest distance L1 between the intra-rotor flow path 34 and the first magnet 41 is a distance between a surface of the inner surface of the intra-rotor flow path 34 facing the radial inside and the second outer surface 41b of the first magnet 41. When viewed in the axial direction, the shortest distance L3 between the intra-rotor flow path 34 and the second magnet 43 is a distance between an arc-shaped portion located on one circumferential direction side (+θ side) of the inner surface of the intra-rotor flow path 34 and the second outer surface 43b of the second magnet 43. When viewed in the axial direction, the shortest distance L4 between the intra-rotor flow path 34 and the second magnet 44 is a distance between an arc-shaped portion located on the other circumferential direction side (−θ side) of the inner surface of the intra-rotor flow path 34 and the second outer surface 44b of the second magnet 44. When viewed in the axial direction, the shortest distance L3 between the intra-rotor flow path 34 and the second magnet 43 and the shortest distance L4 between the intra-rotor flow path 34 and the second magnet 44 are the same. When viewed in the axial direction, the shortest distance L1 between the intra-rotor flow path 34 and the first magnet 41 is shorter than the shortest distances L3 and L4 between the intra-rotor flow path 34 and the second magnets 43 and 44.

The plurality of rotor hole portions 35 are holes penetrating the rotor core 30 in the axial direction. The plurality of rotor hole portions 35 may be holes having a bottom in the axial direction. As illustrated in FIG. 2, the plurality of rotor hole portions 35 are provided at equal intervals over the entire circumference along the circumferential direction. In the present embodiment, eight rotor hole portions 35 are provided. As illustrated in FIG. 3, when viewed in the axial direction, the rotor hole portion 35 is provided at a position overlapping a virtual line Lq that passes through the circumferential center between the magnet holding portions 31 adjacent to each other in the circumferential direction and extends in the radial direction. When viewed in the axial direction, the rotor hole portion 35 has a substantially triangular shape with rounded corners protruding radially outward. By providing the plurality of rotor hole portions 35 in the rotor core 30, the weight of the rotor core 30 can be reduced. In the present embodiment, the virtual line Lq passes on the q axis of the rotor 10 when viewed in the axial direction. A direction where the virtual line Lq extends is a q-axis direction of the rotor 10.

The low thermal conductive layer 80 suppresses heat transfer from the rotor core 30 to the magnet 40. The low thermal conductive layer 80 extends in the axial direction. Although not illustrated, in the present embodiment, the low thermal conductive layer 80 is provided from an end portion on the left side (+Y side) to an end portion on the right side (−Y side) of the magnet 40. The low thermal conductive layer 80 is accommodated in each of the plurality of magnet holes 50. The low thermal conductive layer 80 includes low thermal conductive layers 81, 83, and 84.

As illustrated in FIG. 4, the low thermal conductive layer 81 is provided between the first outer surface 41a and the first inner surface 51e of the first magnet 41 in the first magnet hole 51. The low thermal conductive layer 83 is provided between the first outer surface 43a and the first inner surface 53e of the second magnet 43 in the second magnet hole 53. The low thermal conductive layer 84 is provided between the first outer surface 44a and the first inner surface 54e of the second magnet 44 in the second magnet hole 54. That is, the low thermal conductive layer 80 is provided between each of the first outer surfaces 41a, 43a, and 44a of the plurality of magnets 40 and the rotor core 30.

In the present embodiment, the low thermal conductive layers 81, 83, and 84 are sheet-like members. Each of the low thermal conductive layers 81, 83, and 84 is inserted into each magnet hole 50 together with each magnet 40 in a state of being attached to the first outer surfaces 41a, 43a, and 44a of each magnet 40. Although not illustrated, in the present embodiment, each of the sheet-like low thermal conductive layers 81, 83, and 84 has a substantially rectangular shape extending in the axial direction when viewed in the thickness direction of the low thermal conductive layers 81, 83, and 84. The low thermal conductive layers 81, 83, and 84 disposed in the respective magnet holes 50 are foamed by heating to expand the volume, and are cured in an expanded state. The thermal conductivity of the low thermal conductive layer 80 is smaller than the thermal conductivity of the rotor core 30.

The low thermal conductive layer 81 presses the first magnet 41 against the second inner surface 51f of the first magnet hole 51. The low thermal conductive layer 83 presses the second magnet 43 against the second inner surface 53f of the second magnet hole 53. The low thermal conductive layer 84 presses the second magnet 44 against the second inner surface 54f of the second magnet hole 54. Thus, each magnet 40 is fixed to each magnet hole 50. As a result, the second outer surfaces 41b, 43b, and 44b of the magnets 40 come into contact with the rotor core 30.

In the present embodiment, the low thermal conductive layers 81, 83, and 84 include, for example, a thermosetting resin and a foaming agent foamable by heating. The foaming agent contained in the low thermal conductive layers 81, 83, and 84 is preferably, for example, a foaming agent that foams at a temperature lower than the curing temperature of the thermosetting resin and reaches the most expanded state. As a result, in the process in which the temperature rises during heating of the rotor 10, the thermosetting resin starts to be cured after foaming of the foaming agent is completed, so that the low thermal conductive layers 81, 83, and 84 stably expand. Therefore, each of the plurality of magnets 40 can be pressed against the second inner surfaces 51f, 53f, and 54f of the plurality of magnet holes 50 by the low thermal conductive layers 81, 83, and 84, and each of the plurality of magnets 40 can be stably fixed to the magnet hole 50.

Although not illustrated, an adhesive layer is provided on each of front and back surfaces of the low thermal conductive layers 81, 83, and 84 of the present embodiment. As a result, each magnet 40 can be bonded and fixed to each magnet hole 50 via the low thermal conductive layers 81, 83, and 84. In addition, the low thermal conductive layers 81, 83, and 84 can be stably brought into contact with the first outer surfaces 41a, 43a, and 44a of each of the plurality of magnets 40 and the rotor core 30. An adhesive layer may be provided only on one of the front and back surfaces of the low thermal conductive layers 81, 83, and 84. That is, the low thermal conductive layers 81, 83, and 84 may be bonded and fixed to only one of the magnets 40 or the magnet holes 50. In addition, the low thermal conductive layers 81, 83, and 84 may not be provided with an adhesive layer.

The refrigerant flow path 90 is a path for supplying the refrigerant O stored in the gear housing 63b to the rotor 10 and the stator 61. As illustrated in FIG. 1, the refrigerant flow path 90 is provided with a pump 97 and a cooler 98. The refrigerant flow path 90 includes a first flow path portion 91, a second flow path portion 92, a third flow path portion 93, a fourth flow path portion 94, a fifth flow path portion 95, an intra-shaft flow path 96, and an intra-rotor flow path 34.

The first flow path portion 91, the second flow path portion 92, and the third flow path portion 93 are provided in a wall portion of the gear housing 63b, for example. The first flow path portion 91 connects a lower region in which the refrigerant O is stored in the gear housing 63b and the pump 97. The second flow path portion 92 connects the pump 97 and the cooler 98. The third flow path portion 93 connects the cooler 98 and the fourth flow path portion 94.

The fourth flow path portion 94 is a pipe extending in the axial direction. Both axial ends of the fourth flow path portion 94 are supported by the motor housing 63a. The fourth flow path portion 94 is disposed above the stator 61. The fourth flow path portion 94 has a plurality of supply ports 94a. The supply port 94a is a hole that penetrates the fourth flow path portion 94 in the radial direction. In the present embodiment, the supply port 94a is an injection port that injects a part of the refrigerant O flowing into the fourth flow path portion 94 to the outside of the fourth flow path portion 94. The fifth flow path portion 95 is provided in the lid portion 63e. The fifth flow path portion 95 connects the fourth flow path portion 94 and the intra-shaft flow path 96.

The intra-shaft flow path 96 is formed by the inner surface of the hollow shaft 20. The intra-shaft flow path 96 extends in the axial direction. An end portion on the left side (+Y side) of the intra-shaft flow path 96 is located inside the gear housing 63b and opens to the left side. As described above, the intra-rotor flow path 34 is a hole that penetrates the rotor core 30 in the axial direction. An axially central portion of the intra-rotor flow path 34 is connected to the plurality of hole portions 20a. The intra-rotor flow path 34 is connected to the intra-shaft flow path 96 via the plurality of hole portions 20a.

When the pump 97 is driven, the refrigerant O stored in the lower region in the gear housing 63b is sucked up by the pump 97 through the first flow path portion 91, and flows into the cooler 98 through the second flow path portion 92. The refrigerant O flowing into the cooler 98 is cooled in the cooler 98, and then flows into the fourth flow path portion 94 through the third flow path portion 93. A part of the refrigerant O flowing into the fourth flow path portion 94 is injected from the supply port 94a and supplied to the stator 61. The other part of the refrigerant O flowing into the fourth flow path portion 94 flows into the intra-shaft flow path 96 through the fifth flow path portion 95.

A part of the refrigerant O flowing into the intra-shaft flow path 96 flows into the intra-rotor flow path 34 via the plurality of hole portions 20a. Another part of the refrigerant O flowing through the intra-shaft flow path 96 flows into the gear housing 63b from the opening on the left side (+Y side) of the shaft 20 and is stored again in the lower region in the gear housing 63b.

The refrigerant O flowing into the intra-rotor flow path 34 flows through the intra-rotor flow path 34 toward the left side (+Y side) and the right side (−Y side). The refrigerant O flowing through the intra-rotor flow path 34 comes into contact with the inner surface of the intra-rotor flow path 34, and absorbs the heat of the rotor core 30 and the heat of the plurality of magnets 40. As a result, the heat of the rotor core 30 and the heat of the plurality of magnets 40 are released to the refrigerant O, and the rotor core 30 and the plurality of magnets 40 are cooled. The refrigerant O flowing through the intra-rotor flow path 34 scatters radially outside from both axial ends of the rotor core 30 and is supplied to the stator 61.

The refrigerant O supplied to the stator 61 from the supply port 94a of the fourth flow path portion 94 and both axial ends of the intra-rotor flow path 34 absorbs heat of the stator 61 to cool the stator 61. More specifically, the refrigerant O is supplied to the coil 61c, and absorbs the heat of the coil 61c and the heat of the stator core 61a. The refrigerant O supplied to the stator 61 falls downward and accumulates in a lower region in the motor housing 63a. The refrigerant O accumulated in the lower region in the motor housing 63a returns into the gear housing 63b via the partition opening 63f.

In the rotor 10 of the present embodiment, a portion located on the radially outside is closer to the stator 61, so that a large amount of magnetic flux flowing between the rotor 10 and the stator 61 passes therethrough. Therefore, the magnetic flux passing through the first magnet 41 disposed radially outside the second magnets 43 and 44 is larger than the magnetic flux passing through the second magnets 43 and 44. Therefore, when the rotor 10 is rotated about the center axis J at the time of driving the drive apparatus 1, the amount of change in the magnetic flux passing through the first magnet 41 is larger than the amount of change in the magnetic flux passing through the second magnets 43 and 44, so that the eddy current generated in the first magnet 41 is larger than the eddy current generated in the second magnets 43 and 44. Therefore, in the conventional configuration, the amount of Joule heat generated by the first magnet 41 is larger than the amount of Joule heat generated by the second magnets 43 and 44.

When the drive apparatus 1 is driven, the heat of the stator 61 is transferred to the outer peripheral surface of the rotor core 30 through the gap between the stator core 61a and the rotor core 30, and the radiation heat is generated by the radiation from the stator core 61a, so that the temperature of the outer peripheral surface of the rotor core 30 increases. Since the distance between the first magnet 41 disposed on the radially outside of the second magnets 43 and 44 and the outer peripheral surface of the rotor core 30 is short, the heat of the stator core 61a is easily transferred. The temperature is more likely to rise than the second magnets 43 and 44. As a result, when the drive apparatus 1 is driven, the first magnet 41 is more likely to rise in temperature than the second magnets 43 and 44, and is more likely to demagnetize than the second magnets 43 and 44 due to the temperature rise.

On the other hand, according to the present embodiment, in the rotor 10, the intra-rotor flow path, that is, the flow path 34 is surrounded by the plurality of magnets 40 when viewed in the axial direction, the plurality of magnets 40 include the first magnet 41 and the second magnets 43 and 44, the first magnet 41 is disposed radially outside the second magnets 43 and 44, and the shortest distance L1 between the intra-rotor flow path 34 and the first magnet 41 is shorter than the shortest distances L3 and L4 between the intra-rotor flow path 34 and the second magnets 43 and 44 when viewed in the axial direction. Therefore, the first magnet 41 can be disposed close to the intra-rotor flow path 34. As a result, the heat quantity released from the first magnet 41 to the refrigerant O flowing through the intra-rotor flow path 34 via the rotor core 30 can be increased, and the temperature rise of the first magnet 41 can be suppressed. Therefore, as described above, even when a neodymium magnet not containing heavy rare earths, which is lower in temperature at which demagnetization occurs than a neodymium magnet containing heavy rare earths, is used as the first magnet 41, it is possible to suppress demagnetization of the first magnet 41. Therefore, it is possible to suppress an increase in the manufacturing cost of the first magnet 41 while suppressing a decrease in the output efficiency of the rotary electric machine 60 and the drive apparatus 1.

Further, in the present embodiment, since the second magnets 43 and 44 are disposed on the radial inside of the first magnet 41, the temperature rise is smaller than that of the first magnet 41. Therefore, even when a neodymium magnet containing no heavy rare earth is used as the second magnets 43 and 44, it is possible to suppress demagnetization of the second magnets 43 and 44. Therefore, it is possible to suppress an increase in the manufacturing cost of the second magnets 43 and 44 while suppressing a decrease in the output efficiency of the rotary electric machine 60 and the drive apparatus 1.

In the present embodiment, since the intra-rotor flow path 34 is disposed surrounded by the plurality of magnets 40, each magnet 40 is easily disposed close to the intra-rotor flow path 34. Therefore, since the heat quantity released from each magnet 40 to the refrigerant O can be increased, the temperature rise of each magnet 40 can be more suitably suppressed.

According to the present embodiment, each of the plurality of magnetic poles 10P includes the first magnet 41 and the pair of second magnets 43 and 44, and when viewed in the axial direction, the pair of second magnets 43 and 44 extends in directions away from each other in the circumferential direction from the radial inside toward the radial outside, and the intra-rotor flow path 34 is disposed between the pair of second magnets 43 and 44 in the circumferential direction. Therefore, the second outer surfaces 43b and 44b of the pair of second magnets 43 and 44 can be disposed to face the intra-rotor flow path 34 in the circumferential direction. Therefore, since the longest distance between the intra-rotor flow path 34 and the second outer surfaces 43b and 44b can be shortened, it is possible to suppress variations in the heat radiation amount of the second magnets 43 and 44 in the radial direction, and it is possible to suppress the temperature of a part of the second magnets 43 and 44 from becoming too high.

In the present embodiment, as described above, since the intra-rotor flow path 34 is disposed between the pair of second magnets 43 and 44 in the circumferential direction, the plurality of magnets 40 are easily disposed to surround the intra-rotor flow path 34. As a result, since it is easy to dispose each magnet 40 close to the intra-rotor flow path 34, it is easy to increase the heat quantity released from each magnet 40 to the refrigerant O. Therefore, the temperature rise of each magnet 40 can be more suitably suppressed.

According to the present embodiment, each of the plurality of magnetic poles 10P includes one first magnet 41, and when viewed in the axial direction, the first magnet 41 extends in a direction orthogonal to the magnetic pole virtual line Ld that passes through the circumferential center of the magnetic pole 10P and extends in the radial direction. Therefore, when viewed in the axial direction, the magnetic flux passing through the first magnet 41 tends to increase as compared with the case where the first magnet 41 extends in the direction inclined from the direction orthogonal to the magnetic pole virtual line Ld, and thus the heat quantity of Joule heat generated by the first magnet 41 tends to be larger than the heat quantity of Joule heat generated by the second magnets 43 and 44. On the other hand, in the present embodiment, since the first magnet 41 can be disposed close to the intra-rotor flow path 34 as described above, the heat quantity released from the first magnet 41 to the refrigerant O flowing through the intra-rotor flow path 34 via the rotor core 30 can be increased, and the temperature rise of the first magnet 41 can be suppressed. Therefore, since it is possible to more preferably suppress demagnetization of the first magnet 41, it is possible to more preferably suppress a decrease in the output efficiency of the rotary electric machine 60 and the drive apparatus 1 and to suppress an increase in the manufacturing cost of the first magnet 41.

In the present embodiment, when viewed in the axial direction, the longest distance between the second outer surface 41b of the first magnet 41 and the intra-rotor flow path 34 can be shortened as compared with the case where the first magnet 41 extends in the direction inclined from the direction orthogonal to the magnetic pole virtual line Ld. Therefore, since it is possible to suppress variation in the heat radiation amount of the first magnet 41 in the circumferential direction, it is possible to suppress the temperature of a part of the first magnet 41 from becoming too high.

According to the present embodiment, when viewed in the axial direction, the first magnet 41 and the intra-rotor flow path 34 are disposed at positions overlapping the magnetic pole virtual line Ld, and the intra-rotor flow path 34 extends in a direction orthogonal to the magnetic pole virtual line Ld. Therefore, when viewed in the axial direction, the direction in which the second outer surface 41b of the outer surface of the first magnet 41 facing the intra-rotor flow path 34 side extends and the direction in which the surface of the inner surface of the intra-rotor flow path 34 facing the radial inside extends can be the same direction, so that the longest distance between the second outer surface 41b of the first magnet 41 and the intra-rotor flow path 34 can be shortened. Therefore, in the direction in which the first magnet 41 extends, the variation in the heat radiation amount of the first magnet 41 can be more suitably suppressed, so that the temperature of a part of the first magnet 41 can be more suitably suppressed from becoming high.

In the present embodiment, as described above, since the intra-rotor flow path 34 extends in the direction orthogonal to the magnetic pole virtual line Ld, the area of the surface facing the radial inside of the intra-rotor flow path 34 can be increased. When the rotor 10 rotates about the center axis J, a centrifugal force is applied to the refrigerant O flowing through the intra-rotor flow path 34, so that the refrigerant O easily flows in the axial direction along the surface of the intra-rotor flow path 34 facing the radial inside. As a result, it is possible to increase the contact area between the refrigerant O flowing through the intra-rotor flow path 34 and the radially inside surface of the intra-rotor flow path 34. Therefore, since the heat quantity of the first magnet 41 released to the refrigerant O flowing through the intra-rotor flow path 34 can be more suitably increased, the temperature rise of the first magnet 41 can be more suitably suppressed.

According to the present embodiment, the low thermal conductive layer 80 is provided between the rotor core 30 and the intra-rotor flow path of the plurality of magnets 40, that is, the first outer surfaces 41a, 43a, and 44a facing the opposite side to the flow path 34 side, and the second outer surfaces 41b, 43b, and 44b facing the intra-rotor flow path 34 side of the plurality of magnets 40 are in contact with the rotor core 30, and the thermal conductivity of the low thermal conductive layer 80 is smaller than the thermal conductivity of the rotor core 30. Therefore, the thermal resistance between the first outer surface 41a and the rotor core 30 can be increased as compared with the case where the first outer surface 41a facing the radial outside of the first magnet 41 and the rotor core 30 are in direct contact with each other. Therefore, since the heat quantity transmitted from the stator 61 to the first outer surface 41a via the rotor core 30 can be more suitably suppressed, the temperature rise of the first magnet 41 can be more suitably suppressed.

In the present embodiment, the thermal resistance between the first outer surfaces 41a, 43a, and 44a of the plurality of magnets 40 and the rotor core 30 can be made larger than the thermal resistance between the second outer surfaces 41b, 43b, and 44b of the plurality of magnets 40 and the rotor core 30. Therefore, the heat quantities T12, T32, and T42 released from the second outer surfaces 41b, 43b, and 44b of each magnet 40 to the intra-rotor flow path 34 side can be made relatively larger than the heat quantities T11, T31, and T41 flowing into the first outer surfaces 41a, 43a, and 44a of each magnet 40 from the opposite side of the intra-rotor flow path 34 side. Therefore, the temperature rise of each magnet 40 can be more suitably suppressed.

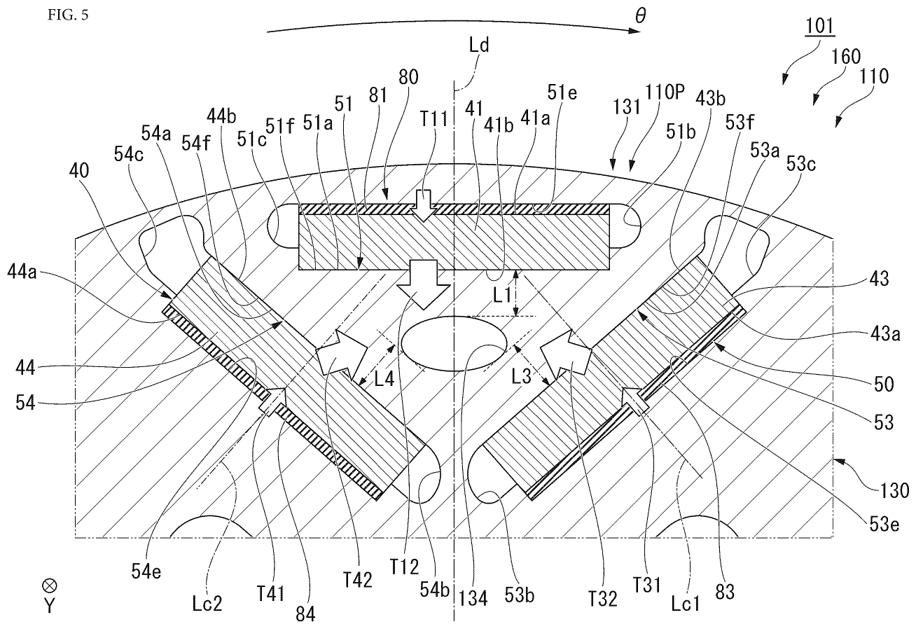

FIG. 5 is a cross-sectional view illustrating a part of a rotor 110 of a drive apparatus 101 according to a modification of the first embodiment. In the following description, the same reference numerals are given to constituent elements of the same aspects as those of the above-described first embodiment, and the description thereof will be omitted.

An intra-rotor flow path 134 provided in a magnet holding portion 131 of each of the plurality of magnetic poles 110P of the present modification has an elliptical shape whose major axis extends in a direction orthogonal to the magnetic pole virtual line Ld when viewed in the axial direction. Therefore, according to the present embodiment, while the shortest distance L1 between the first magnet 41 and the portion on the circumferential center side of the intra-rotor flow path 134 is shortened, the shortest distance between the first magnet hole 51 and the portions on both sides in the circumferential direction of the intra-rotor flow path 134 can be suppressed from being excessively shortened. Therefore, since the heat quantity released from the first magnet 41 to the refrigerant O flowing through the intra-rotor flow path 134 via the rotor core 130 can be increased, it is possible to suppress the thickness of the rotor core 130 between the portions on both sides in the circumferential direction of the intra-rotor flow path 134 and the first magnet hole 51 from becoming too thin while suppressing the temperature rise of the first magnet 41, so that it is possible to suppress the reduction in the rigidity of the portion of the rotor core 130 surrounded by the plurality of magnets 40.

When viewed in the axial direction, the intra-rotor flow path 134 is provided at a position overlapping the magnetic pole virtual line Ld. In the present modification, the magnetic pole virtual line Ld passes through the center of the intra-rotor flow path 134 in the circumferential direction. When viewed in the axial direction, the shapes of both ends in the circumferential direction of the intra-rotor flow path 134 are curved shapes protruding outward in the circumferential direction. Therefore, according to the present modification, similarly to the intra-rotor flow path 34 of the first embodiment described above, it is possible to suppress concentration of stress on a part of the inner surface of the intra-rotor flow path 134. Therefore, when the rotor 110 rotates about the center axis J, the intra-rotor flow path 134 can be suppressed from being deformed by the centrifugal force or the like applied to the rotor core 130, so that the flow rate of the refrigerant O flowing through the intra-rotor flow path 134 can be stabilized. Therefore, since the heat of the rotor core 130 and the plurality of magnets 40 can be stably released via the refrigerant O, the temperature rise of the plurality of magnets 40 can be suppressed.

When viewed in the axial direction, the intra-rotor flow path 134 is disposed radially inside the first virtual line Lc1 and the second virtual line Lc2. Therefore, according to the present modification, similarly to the first embodiment described above, it is possible to suppress the shortest distance between the intra-rotor flow path 134 and each of the first magnet hole 51 and the second magnet holes 53 and 54 from becoming too short. Therefore, it is possible to suppress a decrease in rigidity of a portion surrounded by the plurality of magnets 40 in the rotor core 130.

The intra-rotor flow path 134 is surrounded by one first magnet 41 and a pair of second magnets 43 and 44. When viewed in the axial direction, the shortest distance L1 between the intra-rotor flow path 134 and the first magnet 41 is shorter than the shortest distances L3 and L4 between the intra-rotor flow path 134 and the second magnets 43 and 44. Therefore, according to the present modification, since the first magnet 41 can be disposed close to the intra-rotor flow path 134, the heat quantity released from the first magnet 41 to the refrigerant O can be increased. Therefore, the temperature rise of the first magnet 41 can be more suitably suppressed.

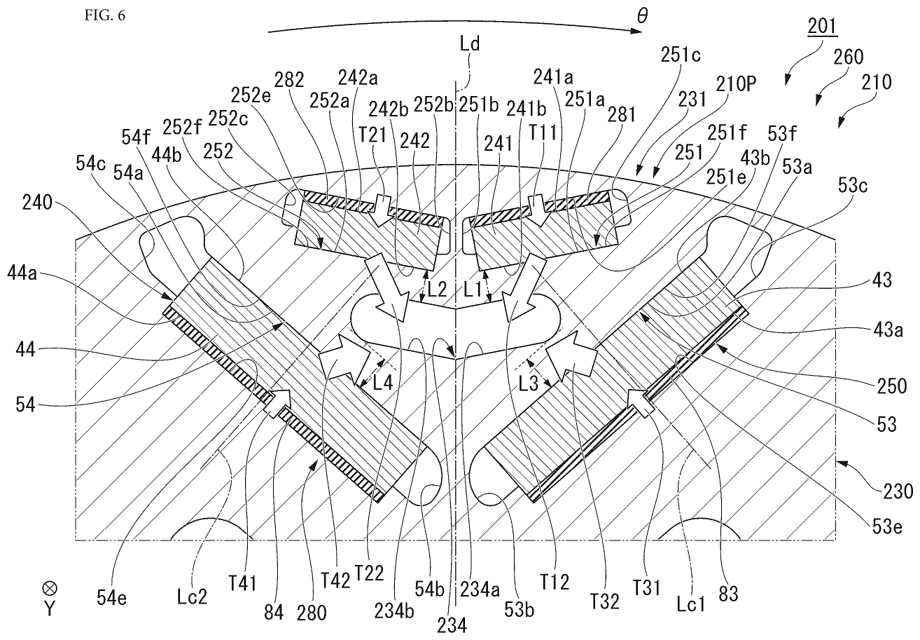

FIG. 6 is a cross-sectional view illustrating a part of a rotor 210 of a drive apparatus 201 according to a second embodiment. In the following description, the same reference numerals are given to constituent elements of the same aspects as those of the above-described first embodiment, and the description thereof will be omitted.

The rotor 210 of the rotary electric machine 260 of the present embodiment includes a shaft 20, a rotor core 230, a plurality of magnets 240, and a low thermal conductive layer 280. The rotor core 230 includes a plurality of magnet holding portions 231 and a plurality of intra-rotor flow paths 234.

In the present embodiment, one intra-rotor flow path 234 and four magnet holes 250 are provided in the plurality of magnet holding portions 231. In the present embodiment, the plurality of magnet holes 250 include first magnet holes 251 and 252 and a pair of second magnet holes 53 and 54 provided radially inside the first magnet holes 251 and 252. The configurations and the like of the second magnet holes 53 and 54 of the present embodiment are the same as the configurations and the like of the second magnet holes 53 and 54 of the above-described first embodiment.

In the present embodiment, the plurality of magnets 240 include a pair of first magnets 241 and 242 accommodated in each of the pair of first magnet holes 251 and 252 and a pair of second magnets 43 and 44 accommodated in each of the pair of second magnet holes 53 and 54. The configurations and the like of the second magnets 43 and 44 of the present embodiment are the same as the configurations and the like of the second magnets 43 and 44 of the above-described first embodiment.

In the present embodiment, each of the plurality of magnetic poles 210P includes one magnet holding portion 231 and a plurality of magnets 240 accommodated in the magnet holes 250 provided in the one magnet holding portion 231. Each of the plurality of magnetic poles 210P includes a pair of first magnet holes 251 and 252, a pair of second magnet holes 53 and 54, a pair of first magnets 241 and 242, and a pair of second magnets 43 and 44. The other configurations of the plurality of magnetic poles 210P are the same as the other configurations of the plurality of magnetic poles 10P of the first embodiment described above.

In each of the magnetic pole 210P, the first magnet hole 251 and the first magnet hole 252 are arranged with the magnetic pole virtual line Ld interposed therebetween in the circumferential direction. The magnetic pole virtual line Ld passes through the circumferential center between the pair of first magnet holes 251 and 252. The first magnet hole 251 is disposed on one circumferential direction side (+θ side) with respect to the magnetic pole virtual line Ld. The first magnet hole 252 is disposed on the other circumferential direction side (−θ side) with respect to the magnetic pole virtual line Ld. The pair of first magnet holes 251 and 252 is disposed between the pair of second magnet holes 53 and 54 in the circumferential direction. When viewed in the axial direction, the pair of first magnet holes 251 and 252 extends in directions away from each other in the circumferential direction from radially inside toward radially outside. When viewed in the axial direction, the pair of first magnet holes 251 and 252 are disposed along a V shape expanding in the circumferential direction toward the radially outside. When viewed in the axial direction, the first magnet hole 251 and the first magnet hole 252 have a line-symmetric shape with the magnetic pole virtual line Ld as a symmetry axis.

The first magnet hole 251 includes a magnet accommodation hole portion 251a, an inner hole portion 251b, and an outer hole portion 251c. When viewed in the axial direction, the magnet accommodation hole portion 251a has a rectangular shape with the direction in which the first magnet hole 251 extends as a long side. The magnet accommodation hole portion 251a is disposed on the radially outside of the intra-rotor flow path 234. The magnet accommodation hole portion 251a has a first inner surface 251e and a second inner surface 251f. The first inner surface 251e is a surface facing the intra-rotor flow path 234 side among the inner surfaces of the magnet accommodation hole portion 251a. The second inner surface 251f is a surface facing the side opposite to the intra-rotor flow path 234 side among the inner surfaces of the magnet accommodation hole portion 251a. The inner hole portion 251b is connected to the radially inner end portion of the magnet accommodation hole portion 251a. The outer hole portion 251c is connected to the radially outer end portion of the magnet accommodation hole portion 251a. The inner hole portion 251b and the outer hole portion 251c constitute a flux barrier portion.

The first magnet hole 252 includes a magnet accommodation hole portion 252a, an inner hole portion 252b, and an outer hole portion 252c. When viewed in the axial direction, the magnet accommodation hole portion 252a has a rectangular shape with the direction in which the first magnet hole 252 extends as a long side. The magnet accommodation hole portion 252a is disposed on the radially outside of the intra-rotor flow path 234. The magnet accommodation hole portion 252a has a first inner surface 252e and a second inner surface 252f. The first inner surface 252e is a surface facing the intra-rotor flow path 234 side among the inner surfaces of the magnet accommodation hole portion 252a. The second inner surface 252f is a surface facing the side opposite to the intra-rotor flow path 234 side among the inner surfaces of the magnet accommodation hole portion 252a. The inner hole portion 252b is connected to the radially inner end portion of the magnet accommodation hole portion 252a. The outer hole portion 252c is connected to the radially outer end portion of the magnet accommodation hole portion 252a. The inner hole portion 252b and the outer hole portion 252c constitute a flux barrier portion. The other configuration and the like of each of the first magnet holes 251 and 252 are the same as the other configuration and the like of the first magnet hole 51 of the above-described embodiment.

When viewed in the axial direction, the pair of first magnets 241 and 242 extend in directions away from each other in the circumferential direction toward the radially outside from the radially inside. When viewed in the axial direction, the pair of first magnets 241 and 242 are disposed along a V shape expanding in the circumferential direction toward the radial outside. The magnetic pole virtual line Ld passes between the pair of first magnets 241 and 242. When viewed in the axial direction, the first magnet 241 and the first magnet 242 have a line-symmetric shape with the magnetic pole virtual line Ld as a symmetry axis. The first magnet 241 is disposed in the magnet accommodation hole portion 251a. The first magnet 242 is disposed in the magnet accommodation hole portion 252a. Each of the first magnets 241 and 242 is disposed radially outside the intra-rotor flow path 234. As a result, the intra-rotor flow path 234 is surrounded by the plurality of magnets 240 when viewed in the axial direction.

The first magnet 241 has a first outer surface 241a and a second outer surface 241b. The first outer surface 241a is a surface of the outer surface of the first magnet 241 facing the side opposite to the intra-rotor flow path 234 side. The first outer surface 241a faces radially outside. The first outer surface 241a faces the first inner surface 251e of the first magnet hole 251. The second outer surface 241b is a surface of the outer surface of the first magnet 241 facing the intra-rotor flow path 234 side. The second outer surface 241b faces radially inward. The second outer surface 241b faces the second inner surface 251f.

The first magnet 242 has a first outer surface 242a and a second outer surface 242b. The first outer surface 242a is a surface of the outer surface of the first magnet 242 facing the side opposite to the intra-rotor flow path 234 side. The first outer surface 242a faces radially outside. The first outer surface 242a faces the first inner surface 252e of the first magnet hole 252. The second outer surface 242b is a surface of the outer surface of the first magnet 242 facing the intra-rotor flow path 234 side. The second outer surface 242b faces the second inner surface 252f. The second outer surface 242b faces radially inward. The other configuration and the like of each of the first magnets 241 and 242 are the same as the other configuration and the like of the first magnet 41 of the above-described embodiment.

The low thermal conductive layer 280 is accommodated in each of the plurality of magnet holes 250. The low thermal conductive layer 280 includes low thermal conductive layers 281, 282, 83, and 84. The configurations and the like of the low thermal conductive layers 83 and 84 of the present embodiment are the same as the configurations and the like of the low thermal conductive layers 83 and 84 of the first embodiment described above.

The low thermal conductive layer 281 is provided between the first outer surface 241a and the first inner surface 251e of the first magnet hole 251. The low thermal conductive layer 282 is provided between the first outer surface 242a and the first inner surface 252e of the first magnet hole 252. That is, the low thermal conductive layer 281 is provided between each of the first outer surfaces 241a and 242a of the first magnets 241 and 242 and the rotor core 230. The thermal conductivity of the low thermal conductive layers 281 and 282 is smaller than the thermal conductivity of the rotor core 230.

The low thermal conductive layer 281 presses the first magnet 241 against the second inner surface 251f. The low thermal conductive layer 282 presses the first magnet 242 against the second inner surface 252f. Thus, the first magnets 241 and 242 are fixed to the first magnet holes 251 and 252, respectively. Thus, each of the second outer surfaces 241b and 242b of the first magnets 241 and 242 is in contact with the rotor core 230. The other configurations and the like of the low thermal conductive layers 281 and 282 are the same as other configurations and the like of the low thermal conductive layer 81 of the above-described embodiment.

The intra-rotor flow path 234 is disposed radially inside the pair of first magnets 241 and 242. In the circumferential direction, the intra-rotor flow path 234 is disposed between the pair of second magnets 43 and 44. The intra-rotor flow path 234 is surrounded by the pair of first magnets 241 and 242 and the pair of second magnets 43 and 44. When viewed in the axial direction, the intra-rotor flow path 234 is disposed radially inside the first virtual line Lc1 and the second virtual line Lc2. Therefore, according to the present embodiment, it is possible to suppress the shortest distance between the intra-rotor flow path 234 and each of the first magnet holes 251 and 252 and the second magnet holes 53 and 54 from becoming too short. Therefore, since the thickness of the rotor core 230 between the intra-rotor flow path 234 and each of the first magnet holes 251 and 252 and the second magnet holes 53 and 54 can be suppressed from becoming too thin, it is possible to suppress the reduction in the rigidity of the portion of the rotor core 230 surrounded by the plurality of magnets 240.

When viewed in the axial direction, the intra-rotor flow path 234 is provided at a position overlapping the magnetic pole virtual line Ld. The magnetic pole virtual line Ld passes through the center of the intra-rotor flow path 234 in the circumferential direction. The intra-rotor flow path 234 includes a first flow path portion 234a and a second flow path portion 234b. The first flow path portion 234a is a portion disposed on one circumferential direction side (+θ side) of the magnetic pole virtual line Ld in the intra-rotor flow path 234. The first flow path portion 234a is disposed radially inside the first magnet 241. The second flow path portion 234b is a portion disposed on the other circumferential direction side (−θ side) with respect to the magnetic pole virtual line Ld in the intra-rotor flow path 234. The second flow path portion 234b is disposed radially inside the first magnet 242. When viewed in the axial direction, the first flow path portion 234a and the second flow path portion 234b extend in directions away from each other in the circumferential direction from the radial inside toward the radial outside. The first flow path portion 234a extends in the direction in which the first magnet 241 extends. The second flow path portion 234b extends in the direction in which the first magnet 242 extends. The radially inner end portion of the first flow path portion 234a and the radially inner end portion of the second flow path portion 234b are connected to each other. In the present embodiment, the first flow path portion 234a and the second flow path portion 234b have a line-symmetrical shape with the magnetic pole virtual line Ld as a symmetry axis when viewed in the axial direction.

When viewed in the axial direction, a shape of an end portion on one circumferential direction side (+θ side) of the first flow path portion 234a is an arc shape protruding to one circumferential direction side, and a shape of an end portion on the other circumferential direction side (−θ side) of the second flow path portion 234b is an arc shape protruding to the other circumferential direction side. That is, both end portions of the intra-rotor flow path 234 in the circumferential direction have an arc shape protruding outward in the circumferential direction. Therefore, according to the present embodiment, similarly to the intra-rotor flow path 34 of the first embodiment described above, it is possible to suppress concentration of stress on a part of the inner surface of the intra-rotor flow path 234. Therefore, when the rotor 210 rotates about the center axis J, the intra-rotor flow path 234 can be suppressed from being deformed by the centrifugal force or the like applied to the rotor core 230, so that the flow rate of the refrigerant O flowing through the intra-rotor flow path 234 can be stabilized.

As described above, the intra-rotor flow path 234 is surrounded by the pair of first magnets 241 and 242 and the pair of second magnets 43 and 44. When viewed in the axial direction, the shortest distances L1 and L2 between the intra-rotor flow path 234 and the first magnets 241 and 242 are shorter than the shortest distances L3 and L4 between the intra-rotor flow path 234 and the second magnets 43 and 44, respectively. Therefore, according to the present embodiment, since each of the first magnets 241 and 242 can be disposed close to the intra-rotor flow path 234, the heat quantity released from the first magnets 241 and 242 to the refrigerant O flowing through the intra-rotor flow path 234 can be increased, and the temperature rise of the first magnets 241 and 242 can be suppressed. Therefore, even when a neodymium magnet containing no heavy rare earth is used as the first magnets 241 and 242, it is possible to suppress demagnetization of the first magnets 241 and 242. Therefore, it is possible to suppress an increase in the manufacturing cost of the first magnets 241 and 242 while suppressing a decrease in the output efficiency of the rotary electric machine 260 and the drive apparatus 201.

According to the present embodiment, each of the plurality of magnetic poles 210P includes the pair of first magnets 241 and 242, the pair of first magnets 241 and 242 extends in directions away from each other in the circumferential direction from the radial inside toward the radial outside when viewed in the axial direction, and the magnetic pole virtual line Ld passing through the circumferential center of the magnetic pole 210P and extending in the radial direction passes between the pair of first magnets 241 and 242 when viewed in the axial direction. In each magnetic pole 210P, a larger amount of magnetic flux flowing between the rotor 210 and the stator 61 passes through a portion on the circumferential center side of each magnetic pole 210P, that is, a portion closer to the magnetic pole virtual line Ld. Therefore, in the first magnets 241 and 242, the magnetic flux passes more in the portion closer to the magnetic pole virtual line Ld, and thus, when the rotor 210 rotates about the center axis J, in the first magnets 241 and 242, the eddy current becomes larger in the portion closer to the magnetic pole virtual line Ld, and thus, the heat quantity of Joule heat becomes larger. On the other hand, in the present embodiment, since the portion closer to the magnetic pole virtual line Ld of the first magnets 241 and 242 is located on the radial inside, the distance from the outer peripheral surface of the rotor core 230 becomes longer. Therefore, the portion closer to the magnetic pole virtual line Ld of the first magnets 241 and 242 can reduce the heat quantity transmitted from the stator 61 to the first outer surfaces 241a and 242a via the rotor core 230. Therefore, as compared with the case where the first magnets 241 and 242 extend in the direction orthogonal to the magnetic pole virtual line Ld, the temperature rise in the portion of the first magnets 241 and 242 close to the magnetic pole virtual line Ld can be suppressed.

According to the present embodiment, when viewed in the axial direction, the intra-rotor flow path 234 is disposed at a position overlapping the magnetic pole virtual line Ld, and the intra-rotor flow path 234 includes the first flow path portion 234a disposed on the radial inside of one first magnet 241 and extending in the direction in which the first magnet 241 extends, and the second flow path portion 234b disposed on the radial inside of the other first magnet 242 and extending in the direction in which the first magnet 242 extends. Therefore, when viewed in the axial direction, the second outer surface 241b of the first magnet 241 and the surface of the first flow path portion 234a facing the radial inside can be arranged in parallel, and the second outer surface 242b of the first magnet 242 and the surface of the second flow path portion 234b facing the radial inside can be disposed in parallel. Therefore, the longest distance between each of the first magnets 241 and 242 and the intra-rotor flow path 234 can be shortened. Therefore, since it is possible to suppress variations in the heat release amount of each of the first magnets 241 and 242 in the circumferential direction, it is possible to suitably suppress an increase in the temperature of a part of each of the first magnets 241 and 242.

In addition, in the present embodiment, as described above, the low thermal conductive layers 281 and 282 are provided between the first outer surfaces 241a and 242a facing the radial outside of each of the pair of first magnets 241 and 242 and the rotor core 230, and the second outer surfaces 241b and 242b facing the radial inside of each of the pair of first magnets 241 and 242 are in direct contact with the rotor core 230. Therefore, the thermal resistance between the first outer surfaces 241a and 242a and the rotor core 230 can be made larger than the thermal resistance between the second outer surfaces 241b and 242b and the rotor core 230. Therefore, the heat quantities T12 and T22 released from the second outer surfaces 241b and 242b of the pair of first magnets 241 and 242 to the rotor core 230 can be made relatively larger than the heat quantities T11 and T21 flowing from the rotor core 230 to the first outer surfaces 241a and 242a of the pair of first magnets 241 and 242, respectively. Therefore, the temperature rise of the first magnets 241 and 242 can be more suitably suppressed.

The present invention is not limited to the above-described embodiments, and other configurations and other methods can be employed within the scope of the technical idea of the present invention. The intra-rotor flow path may have any shape or any arrangement as long as the intra-rotor flow path is surrounded by the plurality of magnets when viewed in the axial direction. For example, when viewed in the axial direction, the intra-rotor flow path may have a circular shape, a rectangular shape, or the like. The type of the refrigerant supplied into the intra-rotor flow path is not particularly limited. A method of supplying the refrigerant into the intra-rotor flow path may be any method.

The number of intra-rotor flow paths provided in one magnet holding portion is not particularly limited as long as it is one or more. When a plurality of intra-rotor flow paths are provided in one magnet holding portion, the plurality of intra-rotor flow paths may be disposed side by side at intervals in the radial direction, or may be disposed side by side at intervals in the circumferential direction. In addition, the rotor hole portion may not be provided.

A rotary electric machine to which the present invention is applied is not limited to a motor, and may be a generator. The application of the rotary electric machine is not particularly limited. The rotary electric machine may be mounted in a device other than the vehicle. The application of the drive apparatus to which the present invention is applied is not particularly limited. For example, the drive apparatus may be mounted in a vehicle for a purpose other than the purpose of rotating the axle, or may be mounted on a device other than the vehicle. The posture when the rotary electric machine and the drive apparatus are used is not particularly limited. The center axis of the rotary electric machine may be inclined with respect to the horizontal direction orthogonal to the vertical direction or may extend in the vertical direction.

Although the embodiment of the present invention has been described above, the respective configurations in the embodiment and combinations thereof are merely examples, and addition, omission, substitution, and other alterations may be appropriately made within a range not departing from the gist of the present invention. Also note that the present invention is not limited by the embodiment.

Note that the present technique can have a configuration below.

(1) A rotor rotatable about a center axis, the rotor including: a rotor core having a plurality of magnet holes and a flow path through which a refrigerant flows; and a plurality of magnets accommodated in each of the plurality of magnet holes, in which the plurality of magnet holes and the flow path each extend in the an direction, the flow path is surrounded by the plurality of magnets when viewed in an axial direction, the plurality of magnets includes a first magnet and a second magnet, the plurality of magnet holes include a first magnet hole that accommodates the first magnet and a second magnet hole that accommodates the second magnet, the first magnet is disposed radially outside the second magnet, and a shortest distance between the flow path and the first magnet is shorter than a shortest distance between the flow path and the second magnet when viewed in an axial direction.

(2) The rotor according to (1), including: a plurality of magnetic poles disposed along a circumferential direction, in which each of the plurality of magnetic poles includes the first magnet and a pair of the second magnets, when viewed in an axial direction, the pair of second magnets extends in directions away from each other in a circumferential direction from a radial inside toward a radial outside, and the flow path is disposed between the pair of second magnets in a circumferential direction.

(3) The rotor according to (2), in which when viewed in an axial direction, each of the plurality of magnetic poles includes one first magnet, and the first magnet extends in a direction orthogonal to a magnetic pole virtual line that passes through a circumferential center of the magnetic pole and extends in a radial direction.

(4) The rotor according to (2), in which each of the plurality of magnetic poles includes a pair of the first magnets, when viewed in an axial direction, the pair of first magnets extends in directions away from each other in a circumferential direction from a radial inside toward a radial outside, and when viewed in the axial direction, a magnetic pole virtual line passing through a circumferential center of the magnetic pole and extending in a radial direction passes between the pair of first magnets.

(5) The rotor according to (3), in which the first magnet and the flow path each are disposed at positions overlapping the magnetic pole virtual line when viewed in an axial direction, and the flow path extends in a direction orthogonal to the magnetic pole virtual line.

(6) The rotor according to (4), in which the flow path is disposed at a position overlapping the magnetic pole virtual line when viewed in an axial direction, the magnetic pole virtual line passes between the pair of first magnets when viewed in an axial direction, and the flow path includes a first flow path portion disposed on a radial inside of one of the first magnets and extending in a direction in which one of the first magnets extends, and a second flow path portion disposed on a radial inside of other one of the first magnets and extending in a direction in which the other one of the first magnets extends.

(7) The rotor according to any one of (1) to (6), in which both ends of the flow path in a circumferential direction have an arc shape protruding outward in a circumferential direction when viewed in an axial direction.

(8) The rotor according to (3) or (4), in which the flow path has an elliptical shape whose major axis extends in a direction orthogonal to the magnetic pole virtual line when viewed in an axial direction.

(9) The rotor according to any one of (2) to (8), in which when viewed in an axial direction, the flow path is disposed radially inside a first virtual line that is orthogonal to a direction in which one of the second magnets extends and passes through a center of one of the second magnets in the direction in which one of the second magnets extends and a second virtual line that is orthogonal to a direction in which other one of the second magnets extends and passes through a center of the other one of the second magnets in a direction in which the other one of the second magnets extends.

(10) The rotor according to any one of (1) to (9), in which a low thermal conductive layer is provided between a first outer surface facing a side opposite to the flow path side of each of the plurality of magnets and the rotor core, a second outer surface facing the flow path side of each of the plurality of magnets is in contact with the rotor core, and a thermal conductivity of the low thermal conductive layer is smaller than a thermal conductivity of the rotor core.

(11) A rotary electric machine including: a rotor according to any one of (1) to (10); and a stator disposed on a radial outside of the rotor.

(12) A drive apparatus including: a rotary electric machine according to (11); and a gear mechanism that is connected to the rotor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a center axis, the rotor comprising:
a rotor core having a plurality of magnet holes and a flow path through which a refrigerant flows; and
a plurality of magnets accommodated in each of the plurality of magnet holes, wherein
the plurality of magnet holes and the flow path each extend in the an axial direction,
the flow path is surrounded by the plurality of magnets when viewed in an axial direction,
the plurality of magnets includes a first magnet and a second magnet,
the plurality of magnet holes include a first magnet hole that accommodates the first magnet and a second magnet hole that accommodates the second magnet,
the first magnet is disposed radially outside the second magnet, and
a shortest distance between the flow path and the first magnet is shorter than a shortest distance between the flow path and the second magnet when viewed in an axial direction.

2. The rotor according to claim 1, comprising a plurality of magnetic poles disposed along a circumferential direction, wherein
each of the plurality of magnetic poles includes the first magnet and a pair of the second magnets,
when viewed in an axial direction, the pair of second magnets extends in directions away from each other in a circumferential direction from a radial inside toward a radial outside, and
the flow path is disposed between the pair of second magnets in a circumferential direction.

3. The rotor according to claim 2, wherein
each of the plurality of magnetic poles includes one first magnet, and
when viewed in an axial direction, the first magnet extends in a direction orthogonal to a magnetic pole virtual line that passes through a circumferential center of the magnetic pole and extends in a radial direction.

4. The rotor according to claim 2, wherein
each of the plurality of magnetic poles includes a pair of the first magnets,
when viewed in an axial direction, the pair of first magnets extends in directions away from each other in a circumferential direction from a radial inside toward a radial outside, and
when viewed in the axial direction, a magnetic pole virtual line passing through a circumferential center of the magnetic pole and extending in a radial direction passes between the pair of first magnets.

5. The rotor according to claim 3, wherein
the first magnet and the flow path each are disposed at positions overlapping the magnetic pole virtual line when viewed in an axial direction, and
the flow path extends in a direction orthogonal to the magnetic pole virtual line.

6. The rotor according to claim 4, wherein
the flow path is disposed at a position overlapping the magnetic pole virtual line when viewed in an axial direction,
the magnetic pole virtual line passes between the pair of first magnets when viewed in an axial direction, and
the flow path includes a first flow path portion disposed on a radial inside of one of the first magnets and extending in a direction in which one of the first magnets extends, and a second flow path portion disposed on a radial inside of other one of the first magnets and extending in a direction in which the other one of the first magnets extends.

7. The rotor according to claim 1, wherein both ends of the flow path in a circumferential direction have an arc shape protruding outward in a circumferential direction when viewed in an axial direction.

8. The rotor according to claim 3, wherein the flow path has an elliptical shape whose major axis extends in a direction orthogonal to the magnetic pole virtual line when viewed in an axial direction.

9. The rotor according to claim 2, wherein when viewed in an axial direction, the flow path is disposed radially inside a first virtual line that is orthogonal to a direction in which one of the second magnets extends and passes through a center of one of the second magnets in the direction in which one of the second magnets extends and a second virtual line that is orthogonal to a direction in which other one of the second magnets extends and passes through a center of the other one of the second magnets in a direction in which the other one of the second magnets extends.

10. The rotor according to claim 1, wherein
a low thermal conductive layer is provided between a first outer surface facing a side opposite to the flow path side of each of the plurality of magnets and the rotor core,
a second outer surface facing the flow path side of each of the plurality of magnets is in contact with the rotor core, and
a thermal conductivity of the low thermal conductive layer is smaller than a thermal conductivity of the rotor core.

11. A rotary electric machine comprising:
the rotor according to claim 1; and
a stator disposed on a radial outside of the rotor.

12. A drive apparatus comprising:
the rotary electric machine according to claim 11; and
a gear mechanism that is connected to the rotor.
